(19) United States
(12) Patent Application Publication
(10) Pub. No.: US 2024/0419789 A1
(43) Pub. Date: Dec. 19, 2024

(54) INTELLIGENT SYSTEM FOR DYNAMIC DETECTION OF APPLICATION SUBMISSIONS CREATED BY AUTONOMOUS SOFTWARE PROGRAMS

(71) Applicant: BANK OF AMERICA CORPORATION, Charlotte, NC (US)

(72) Inventors: Saurabh Garg, Faridabad (IN); Abhijit Behera, Hyderabad (IN); Paul Martin Mattison, Sherrills Ford, NC (US); Maneesh Sethia, Hyderabad (IN)

(73) Assignee: BANK OF AMERICA CORPORATION, Charlotte, NC (US)

(21) Appl. No.: 18/210,312

(22) Filed: Jun. 15, 2023

(51) Int. Cl. G06F 21/55

(52) U.S. Cl. CPC G06F 21/554; G06F 2221/033

(57) ABSTRACT

Artificial intelligence, in the form of machine-learning models, are implemented to dynamically detect when an online or mobile app application is being filled-out/submitted by an autonomous software program/bot (e.g., an invalid application submission), as opposed to a human (i.e., a valid application submission). Telemetry data is captured from the mobile application or web/online application that is indicative as to whether the application forms are being filled-out by a human or an autonomous software program. The telemetry data is applied to machine learning models to determine if the telemetry data results in a recognized pattern that indicates autonomous software program data entry or, conversely, human data entry. In the event that an application submission is determined to be filled-out by an autonomous software program/bot, subsequent submission and/or further processing of the application is denied.

### FIELD OF THE INVENTION

The present invention is related generally to computing network security and, more specifically, systems and methods for dynamically detecting during a mobile app or online application submission that the application is being submitted by an autonomous software program (e.g., bot or the like).

### BACKGROUND

An autonomous software program, commonly referred to as a “bot” is a computer program that performs automatic, repetitive and, in certain instances, harmful tasks. An Internet-based autonomous software program, commonly referred as an “Internet bot” or “web robot” runs automated tasks over the Internet, usually with the intent of imitating human activity. One specific instance is the use of Internet bots to fill-out and submit online applications, for example, online applications for financial accounts and the like, with the goal being creation of fake accounts. When Internet bots are implemented for application submission purposes, they are often capable of inundating the application submission system with a voluminous number of submissions over a relatively short period time. Such an attack on the application submission system may slow down valid application submissions (i.e., submissions performed by humans) and, in certain instances, shut down the application submission system altogether.

Moreover, when autonomous software program application submissions successfully generate a fake account, manual processing is needed to identify the account, verifying that the account is fake and delete the account from the system. Such processing becomes a daunting task when the number of fake accounts is overwhelming.

Therefore, a need exists to develop systems, methods, computer program products that dynamically identify, during application data entry or prior to application submission, that an application is being filled-out and/or submitted by an autonomous software program (e.g., bot or the like). By identifying such application submissions prior to or at the point of submission, the desired systems, methods and the like will decrease and, in some instances, eliminate the need unnecessary process of subsequently identifying and deleting fake accounts.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by implementing machine-learning models to dynamically detect when an online or mobile app application is being filled-out/submitted by a human (i.e., a valid application submission) or an autonomous software program/bot (e.g., an invalid application submission). The invention captures telemetry data from the mobile application or web/online application that is indicative as to whether the application forms are being filled-out by a human or an autonomous software program. Such telemetry data may include, but is not limited to, Internet Protocol (IP) address and geo-location of data entrant, time for completing the application, rate at which data is being entered (e.g., typing speed), data entry order/sequence, page rendering parameters, user interface interactions and the like. The telemetry data is used as inputs to the machine learning models to determine if the telemetry data matches (or is otherwise within the range of) a pattern that indicates human data entry or, conversely, autonomous software program data entry. In the event that an application submission is determined to be filled-out by an autonomous software program, subsequent submission and/or further processing of the application (i.e., entry of the application into the processing system) is denied.

In additional specific embodiments of the invention, the autonomous software program detection system relies on other means of detecting or verifying human versus autonomous software program data entry. For example, the system may be configured to check for tampering of Cascading Style Sheets (CSSs) in JavaScript (JS), the network and/or the local cache. In addition, the system may be configured to provide the capability to determine if multiple application submissions are being submitted simultaneously with the same data entry pattern(s) and/or from the same IP address and geo-location combination, which is indicative of autonomous software program submissions. Moreover, the system may perform external verifications, such as contact information (mobile telephone number, email address, mailing address or the like) validations, driver license number validations or the like to ensure that the data entrant is a human.

A system for dynamic detection of application submissions generated by autonomous software programs defines first embodiments of the invention. The system includes one or more machine-learning models that have been trained to recognize patterns associated with application submittal performed within an online/web application platform or a mobile application. The patterns may be indicative of human data entry or autonomous software program/bot data entry.

The system additionally includes a computing platform having a memory and one or more computing processor devices in communication with the memory. The memory stores autonomous software program detection application that is executable by at least one of the one or more computing processor devices. The autonomous software program detection application is configured to detect data entry within an application form of a mobile app or online platform. In response to detecting data entry is occurring in the application form, the autonomous software program detection application is configured to capture telemetry data associated with the application form. In response to capturing the telemetry data, the detection application is further configured to apply the telemetry data to at least one of the one or more machine-learning models. Subsequently, the autonomous software program detection application is configured to determine whether the data entrant is a human or an autonomous software program based on the captured telemetry data matching/meeting one or more of the patterns and, and, in response to determining that the data entrant is an autonomous software program, deny the application form from being submitted for further processing.

In specific embodiments of the system, the patterns recognized by the machine learning models include a timing pattern for application form completion. In such embodiments of the system, the autonomous software program detection application is configured to (i) capture telemetry data including a time for application form completion and (ii) determine whether the data entry is being made by a human or an autonomous software program based on the time for application form completion meeting the timing pattern.

In other specific embodiments of the system, the patterns recognized by the machine learning models include at least one of (i) a data entry rate pattern (i.e., the typing speed), and (ii) a data entry sequence/order pattern (i.e., the order in which data entries are made). In such embodiments of the system, the autonomous software program detection application is configured to (a) capture telemetry data including at least one of a current data entry rate and a current data entry sequence, and (b) determine whether the data entry is being made by a human or an autonomous software program based on at least one of the current data entry rate meeting the data entry rate pattern and the current data entry sequence meeting the data entry sequence pattern.

In other specific embodiments of the system, the patterns recognized by the machine learning models include a page rendering pattern for loading pages on the online platform or mobile application. Such a page rendering pattern may include, but is not limited to, (i) JavaScript (JS) files that are loaded, (ii) Cascading Style Sheet (CSS) that are loaded, (iii) source code that is loaded, and (iv) events triggered on web page. In such embodiments of the system, the autonomous software program detection application is configured to (i) capture telemetry data including page rendering parameters and (ii) determine whether the data entry is being made by a human or an autonomous software program based on the page rendering parameters meeting the page rendering pattern.

In other specific embodiments of the system, the patterns recognized by the machine learning models include a user interface interaction pattern. In such embodiments of the system, the autonomous software program detection application is configured to (i) capture telemetry data including user interface interactions, and (ii) determine whether the data entry is being made by a human or an autonomous software program based on the user interface interactions meeting the user interface interaction pattern.

In still further specific embodiments of the system, the autonomous software program detection application is further configured to monitor for changes in an Internet Protocol (IP) address and geographic (geo) location of the data entrant and determine whether the data entry is being made by a human or an autonomous software program based further on monitored changes in the IP address and geo location of the data entrant. In further specific embodiments of the system, the autonomous software program detection application is further configured to monitor for data entrant tampering of at least one selected from the group consisting of (i) Cascading Style Sheet (CSS) in JavaScript (JS), (ii) local cache, and (iii) communication network and determine whether the data entry is being made by a human or an autonomous software program based further on data entrant tampering of the at least one selected from the group consisting of (i) CSS in JS, (ii) local cache, and (iii) communication network.

Moreover, in further specific embodiments of the system, the autonomous software program detection application is further configured to receive mobile telephone intelligence that indicates that a mobile telephone being used by the data entrant has been reported, tracked or undergone Subscriber Identity Module (SIM) card exchange and determine whether the data entry is being made by a human or an autonomous software program based further on reporting, tracking or SIM card exchange of/within the mobile telephone being used by the data entrant.

In additional specific embodiments of the system, the autonomous software program detection application is further configured to attempt identity verification of the data entrant based on data entries made to the application form and determine whether the data entry is being made by a human or an autonomous software program based further on results of the attempted identity verification of the data entrant. In further specific embodiments of the system, the autonomous software program detection application is further configured to compare the IP address of a data entrant to an IP addresses currently listed on an IP address deny list and determine whether the data entry is being made by a human or an autonomous software program based further on the comparison between the IP address of the data entrant and the IP addresses currently listed on the IP address deny list.

In additional specific embodiments of the system, the memory further stores an authorization gateway application that is executable by at least one of the one or more computing processor devices and configured to, in response to determining that the data entrant is a human, (i) contact a corresponding motor vehicle commission to validate a driver license number associated with the data entrant and/or (ii) contact a verification system to validate at least one selected from the group consisting of the data entrant's (a) mobile telephone number, (b) electronic mail address, and (c) mailing address.

A computer-implemented method for dynamic detection of application submissions generated by autonomous software programs defines second embodiments of the invention. The method is executable by one or more computing device processors. The method includes generating machine-learning models trained to recognize patterns associated with application submittal performed within (i) an online platform or (ii) a mobile application. Further, the method includes detecting data entry is occurring in an application form within the mobile app or online platform, and, in response to such detection, capturing telemetry data associated with the application form. In addition, the method includes applying the captured telemetry data to at least one of the one or more machine-learning models to recognize one or more of the patterns. Further, the method includes determining whether the data entrant is a human or an autonomous software program based, at least, on the recognized patterns and the captured telemetry data. In response to determining that the data entrant is an autonomous software program, the method includes denying the application form from being submitted for further processing.

In specific embodiments of the computer-implemented method, generating further includes generating the machine-learning models trained to recognize patterns, including at least one of (i) a timing pattern for application form completion, (ii) a data entry pattern, and (iii) a data entry sequence pattern, associated with application submittal. In such embodiments of the computer-implemented method, capturing the telemetry data, includes capturing at least one of (i) a time for application form completion, (ii) a current data entry rate, and (iii) a current data entry sequence, and determining further includes determining whether the data entry is being made by a human or an autonomous software program is based on at least one of (i) the time for application form completion meeting the timing pattern, (ii) the current data entry rate meeting the data entry rate pattern, and (iii) the current data entry sequence meeting the data entry sequence pattern.

In other specific embodiments of the computer-implemented method, generating further includes generating the machine-learning models trained to recognize patterns, including a page rendering pattern, associated with application submittal. The page rendering pattern includes (i) JavaScript (JS) files that are loaded, (ii) Cascading Style Sheet (CSS) that are loaded, (iii) source code that is loaded, and/or (iv) events triggered on web page(s). In such embodiments of the computer-implemented method, capturing the telemetry data includes capturing page rendering parameters, and determining further includes determining whether the data entry is being made by a human or an autonomous software program is based on the page rendering parameters meeting the page rendering pattern.

In still further specific embodiments, the computer-implemented method includes monitor for (i) changes in an Internet Protocol (IP) address and geographic (geo) location of the data entrant and/or (ii) data entrant tampering of (a) Cascading Style Sheet (CSS) in JavaScript (JS), (b) local cache, and/or (c) communication network. In such embodiments of the computer-implemented method determining further includes determining whether the data entry is being made by a human or an autonomous software program based further on the monitored (i) changes in the IP address and geo location of the data entrant and/or (ii) data entrant tampering of the at least one selected from the group consisting of (a) CSS in JS, (b) local cache, and (c) communication network.

A computer program product including a non-transitory computer-readable medium defines third embodiments of the invention. The computer-readable medium includes sets of codes for causing one or more computing devices to generate machine-learning models trained to recognize patterns associated with application submittal performed within (i) an online platform or (ii) a mobile application. The sets of codes further cause the computing device(s) to, in response to detect data entry occurring in an application form within the mobile app or online platform, and, in response to such detection, capture telemetry data associated with the application form. The sets of codes further cause the computing device(s) to apply the captured telemetry data to one or more of the machine-learning models to recognize one or more of the patterns. Further, the sets of codes further cause the computing device(s) to determine whether the data entrant is a human or an autonomous software program based on the captured telemetry data meeting the recognized patterns and, and, in response to determining that the data entrant is an autonomous software program, deny the application form from being submitted for further processing.

In specific embodiments of the computer program product, the set of codes for causing the one or more computing devices to generate the machine-learning models are further configured to cause the one or more computing devices to generate the machine-learning models trained to recognize patterns, including (i) a timing pattern for application form completion, (ii) a data entry pattern, and (ii) a data entry sequence pattern, associated with application submittal. In related embodiments of the computer program product, the set of codes for causing the one or more computing devices to capture the telemetry data are further configured to cause the one or more computing devices to capture the telemetry data including (i) a time for application form completion, (ii) a current data entry rate, and (iii) a current data entry sequence. Further, the set of codes for causing the one or more computing devices to determine whether the data entry is being made by a human or an autonomous software program are further configured to cause the one or more computing devices to determine whether the data entry is being made by a human or an autonomous software program is based on comparison of (i) the timing pattern to the time for application form completion, (ii) the data entry rate pattern to the current data entry rate, and (iii) the data entry sequence pattern to the current data entry sequence.

Thus, according to embodiments of the invention, which will be discussed in greater detail below, the present invention provides for implementing artificial intelligence in the form of machine-learning models to dynamically detect when an online or mobile app application is being filled-out/submitted by an autonomous software program/bot (e.g., an invalid application submission), as opposed to a human (i.e., a valid application submission). The invention captures telemetry data from the mobile application or web/online application that is indicative as to whether the application forms are being filled-out by a human or an autonomous software program. The telemetry data is compared to patterns recognized by the machine learning models to determine if the telemetry data matches a pattern that indicates autonomous software program data entry or, conversely, human data entry. In the event that an application submission is determined to be filled-out by an autonomous software program/bot, subsequent submission and/or further processing of the application (i.e., entry of the application into the processing system) is denied.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the disclosure in general terms, reference will now be made to the accompanying drawings, wherein:

FIG. 1 is a schematic/block diagram of system for dynamic detection of mobile app or online application submittals generated by autonomous software programs, in accordance with embodiments of the present invention;

FIG. 2 is a block diagram of a machine learning model(s) highlighting various types of patterns that the models are trained to recognize, in accordance with embodiments of the present invention;

FIG. 3 is a block diagram of a computing platform including aa autonomous software detection application configured to dynamic detect application submittals generated by autonomous software programs, in accordance with embodiments of the present invention; and

FIG. 4 is a block diagram of a verifying mobile app or online application submittal including dynamic detection of application submittals generated by autonomous software programs, in accordance with embodiments of the invention; and

FIG. 5 is a flow diagram of a method for dynamic detection of mobile app or online application submittals generated by autonomous software programs, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as a system, a method, a computer program product or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as JAVA, PERL, SMALLTALK, C++, PYTHON or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or systems. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the invention.

As the phrase is used herein, a processor may be “configured to” perform or “configured for” performing a certain function in a variety of ways, including, for example, by having one or more general-purpose circuits perform the function by executing particular computer-executable program code embodied in computer-readable medium, and/or by having one or more application-specific circuits perform the function.

Thus, according to embodiments of the invention, which will be described in more detail below, systems, methods and computer program products are disclosed that implement machine-learning models to dynamically detect when an online/mobile application-based application is being filled-out/submitted by a human (i.e., a valid application submission) or an autonomous software program/bot (e.g., an invalid application submission). The invention captures telemetry data from the mobile application or web/online application that is indicative as to whether the application forms are being filled-out by a human or an autonomous software program. Such telemetry data may include, but is not limited to, Internet Protocol (IP) address and geo-location of data entrant, time for completing the application, rate at which data is being entered (e.g., typing speed), data entry order/sequence, page rendering parameters, user interface interactions and the like. The telemetry data is applied to the machine learning models to recognize patterns that indicates human data entry or, conversely, autonomous software program data entry. In the event that an application submission is determined to be filled-out by an autonomous software program, subsequent submission and/or further processing of the application (i.e., entry of the application into the processing system) is denied.

In additional specific embodiments of the invention, the autonomous software program detection system relies on other means of detecting the use of an autonomous software program and/or verifying human data entry. For example, the system may be configured to check for tampering of Cascading Style Sheets (CSSs) in JavaScript (JS), the network and/or the local cache. In addition, the system may be configured to provide the capability to determine if multiple application submissions are being submitted simultaneously with the same data entry pattern(s) and/or from the same IP address and geo-location combination, which is indicative of autonomous software program submissions. Moreover, the system may perform external verifications, such as contact information (mobile telephone number, email address, mailing address or the like) validations, driver license number validations or the like to ensure that the data entrant is a human.

As a result, the present invention seeks to lessen the computing processing burden placed on the online application, mobile application and/or computing network when autonomous software programs inundate the applications and/or networks with application submissions seeking to generate fake accounts. Moreover, by denying the applications dynamically, prior to or at the point of submission, further downstream processing of the applications is prevented.

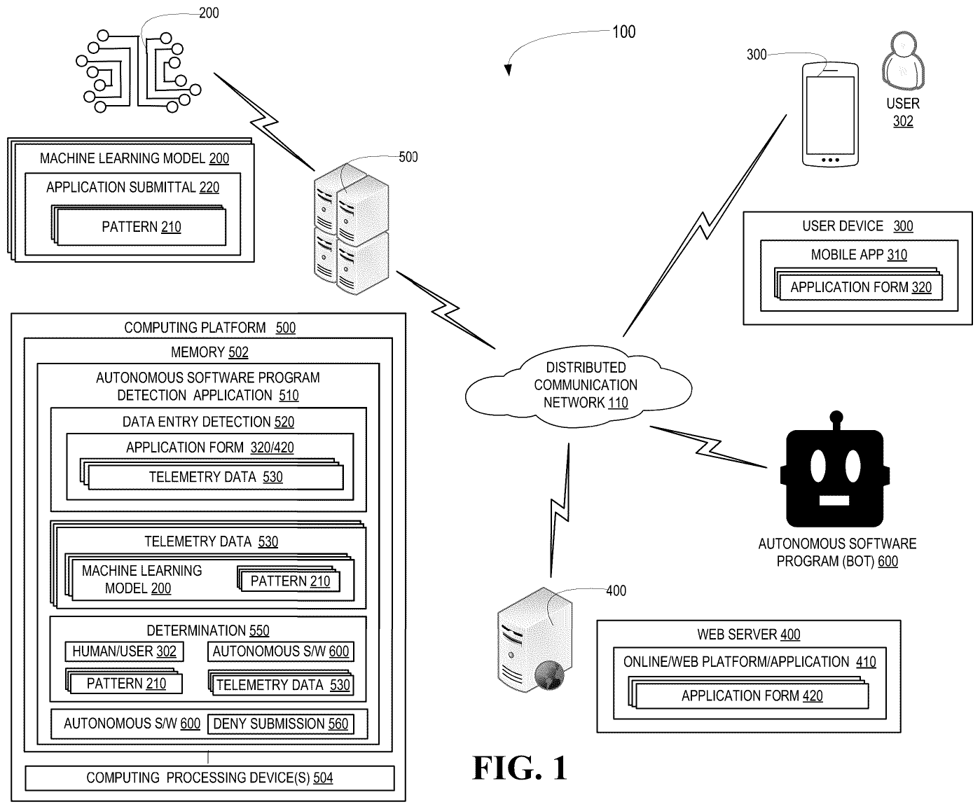

Referring to FIG. 1, a schematic/block diagram is presented of a system 100 for dynamic detection of mobile app/online application submissions generated by autonomous software programs, in accordance with embodiments of the invention. The system 100 is implemented within a distributed communication network 110, which may include the Internet, one or more intranets, one or more cellular networks or the like. The system 100 includes one or more machine learning models 200 that have been trained, over time, to recognize patterns 210 associated with application submittals 220 performed within an online/web platform/application 410 or a mobile application (i.e., “mobile app”) 310. The patterns 210 may indicate application submissions generated by a human (i.e., valid submission), such as user 302 or by an autonomous software program 600, such as a so-called “bot” (i.e., invalid submission attempting to generating a fake account or the like).

System 100 additionally includes computing platform 500, which may comprise one or more application servers or the like. Computing platform 500 includes a memory 502 and one or more computing processing devices 504 in communication with memory 502. Memory 502 stores autonomous software program detection application 510 that is executable by at least one of the computing device processor(s) 504. Autonomous software program detection application 510 is configured to detect 520 data entry is occurring within an application form 420 within online/web platform/application 410 (executed on web server 400) or an application form 320 within the mobile app 310 (executed on user device 300). In response to data entry detection 520, autonomous software program detection application 510 is configured dynamically capture telemetry data 530 associated with data entry process and/or application form 320, 420.

Further, autonomous software program detection application 510 is configured to apply the captured telemetry data 530 to one or more of the machine learning models 200 to recognize one or more of the patterns 210. In response to recognizing patterns 210, autonomous software program detection application 510 is further configured to determine 550 whether the data entrant is human (i.e., user 302) or an autonomous software program/bot 600 based, at least on the recognized patterns 210 and the captured telemetry data 530.

Moreover, autonomous software program detection application 510 is configured to, in response to determining that the data entrant is an autonomous software program/bot 600, deny submission 560 of the application 320, 420 for further processing. In this regard, if the autonomous software program detection application 510 makes the determination 550 prior to the autonomous software program/bot 600 submitting the application, the submission may be denied (or the submission may be accepted and subsequent processing denied so that the autonomous software program/bot 600 is unaware of the detection). Conversely, if the autonomous software program detection application 510 makes the determination 550 simultaneous with the autonomous software program/bot 600 submitting the application or a brief period after the autonomous software program/bot 600 submits the application, the application may be dropped and/or further processing of the application may be denied.

As result, the present invention lessens the computing processing burden placed on the online application, mobile application and/or computing network when autonomous software programs inundate the applications and/or networks with application submissions seeking to generate fake accounts. Moreover, by denying the applications dynamically, prior to or at the point of submission, further downstream processing of the applications is prevented.

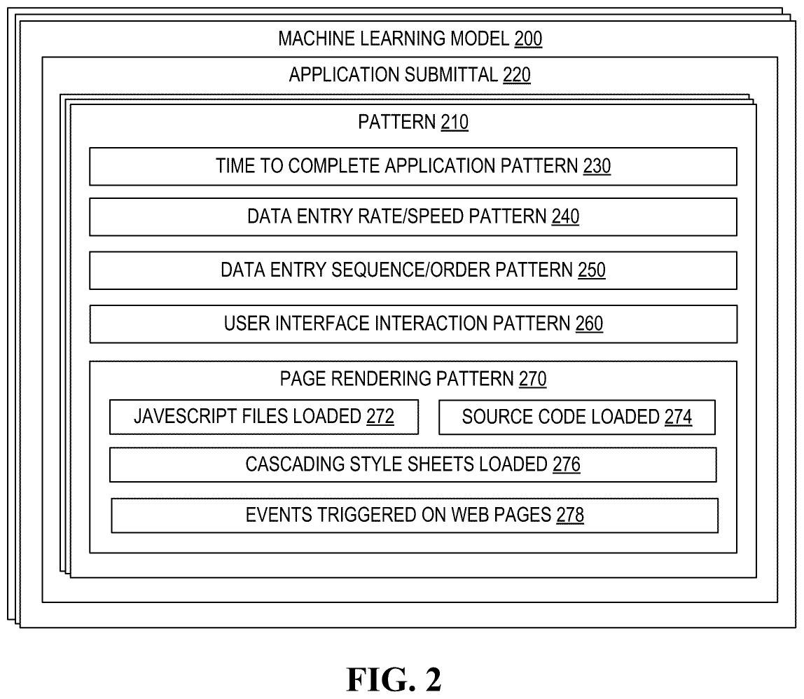

Referring to a FIG. 2, a block diagram is presented of machine learning model(s) 200, in accordance with embodiments of the present invention. Specifically, FIG. 2 highlights various different types of patterns 210 associated with application submittal 220 that the machine learning models 200 have been trained to recognize. The patterns 210 described in relation to FIG. 2 should not be viewed as limiting, in that more different types of patterns 200 are contemplated and within the scope of the invention herein described.

Patterns 200 that the machine learning models 200 have been trained to recognize may include a time to complete application pattern 230 that indicates an average time range in which either a human or an autonomous software program takes to complete the application form(s). Time to complete may be indicated by the time to fill-in all required data entry fields or the like. Typically, an autonomous software program will complete the application (i.e., fill-in all required data entry fields) in a significantly shorter time period (e.g., seconds) than a human (e.g., minutes). Similarly, patterns 220 may include a data entry rate/speed pattern 240 that indicates the rate or speed at which the data is being entered into data entry fields. Typically, an autonomous software program will have a much faster data entry rate than a human.

In further embodiments of the invention, patterns 220 may include a data entry sequence/order pattern 250 that indicates the order in which data is inputted into data entry fields. Typically, humans will enter data top to bottom and/or left to right as the data entry fields are presented to the human, while autonomous software programs tend to randomly input data into data entry fields (i.e., no consistent sequence or order). Further, patterns 220 may include a user interface interaction pattern 260 that indicates user interactions with one or more user interfaces, such as a tab functions with a mouse or touchscreen, toolbar interactions or the like. Typically, an autonomous software program will fill-in data entry fields without having to interact with user interfaces.

In further embodiments of the invention, patterns 220 may include a page rendering pattern 270 that indicates various features of rendering web pages, such as loaded JavaScript® (JS) files 272, loaded source code 274, loaded cascading style sheets (CSSs) 276, events 278 triggered on web pages and the like. Typically, human interaction with the data entry fields in the application forms will result in different page rendering patterns than are exhibited by autonomous software program interactions with the data entry fields.

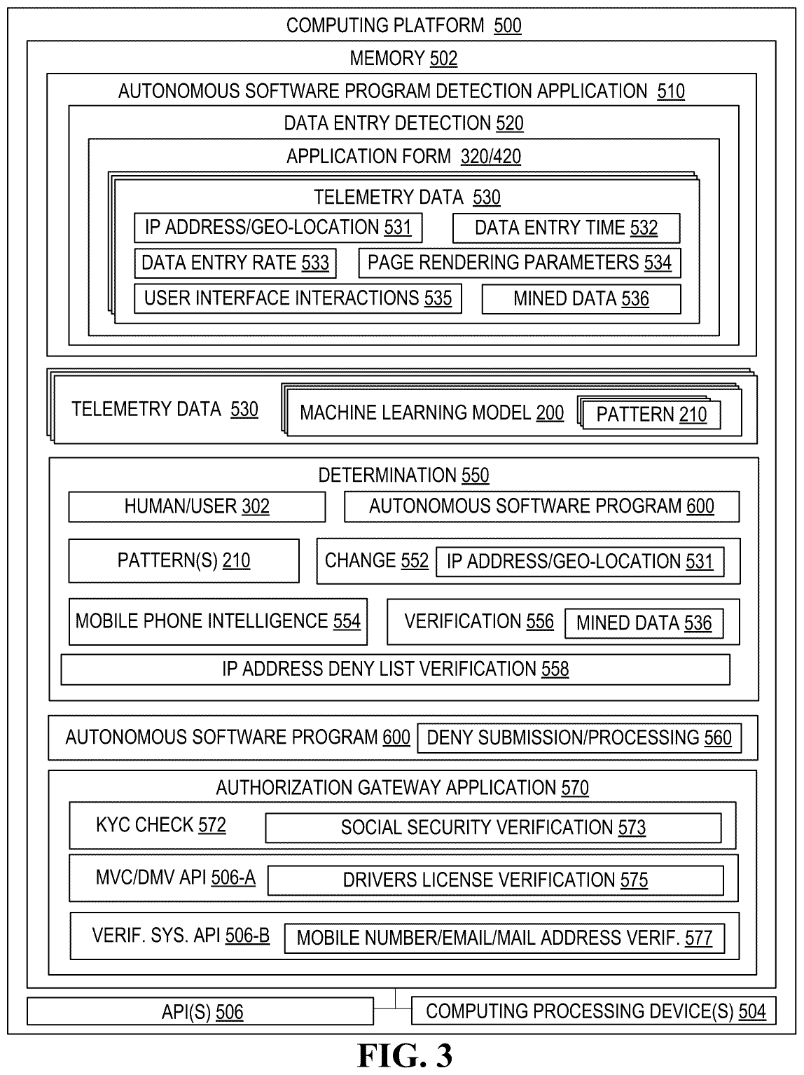

Referring to FIG. 3, a block diagram is presented of computing platform 500, in accordance with embodiments of the present invention. In addition to providing greater details of autonomous software program detection application 510, FIG. 3 highlights various alternate embodiments of the invention. Computing platform 500 may comprise one or multiple devices, such as application servers or the like. Computing platform 500 includes memory 502, which may comprise volatile and/or non-volatile memory, such as read-only and/or random-access memory (RAM and ROM), EPROM, EEPROM, flash cards, or any memory common to computing platforms). Moreover, memory 502 may comprise cloud storage, such as provided by a cloud storage service and/or a cloud connection service.

Further, computing platform 300 includes one or more computing processing devices 504, which may be an application-specific integrated circuit (“ASIC”), or other chipset, logic circuit, or other data processing device. Computing processing device(s) 504 may execute one or more application programming interface (APIs) 506 that interface with any resident programs, such as autonomous software program detection application 510 or the like, stored in memory 502 of computing platform 500 and any external programs. Computing processing devices(s) 504 may include various processing subsystems (not shown in FIG. 3) embodied in hardware, firmware, software, and combinations thereof, that enable the functionality of computing platform 500 and the operability of computing platform 500 on a distributed communication network 110 (shown in FIG. 1), such as the Internet, intranet(s), cellular network(s) and the like. For example, processing subsystems allow for initiating and maintaining communications and exchanging data with other networked devices. For the disclosed aspects, processing subsystems of computing platform 500 may include any subsystem used in conjunction with autonomous software program detection application 510 and related tools, routines, sub-routines, algorithms, sub-algorithms, sub-modules thereof.

In specific embodiments of the present invention, computing platform 500 additionally includes a communications module (not shown in FIG. 3) embodied in hardware, firmware, software, and combinations thereof, that enables electronic communications between components of computing platform 5300 and other networks and network devices. Thus, communication module may include the requisite hardware, firmware, software and/or combinations thereof for establishing and maintaining a network communication connection with one or more devices and/or networks.

Memory 502 of computing platform 500 stores autonomous software program detection application 510, which is executable by at least one of the one or more computing processor devices 504. As previously discussed in relation to FIG. 1, autonomous software program detection application 510 is configured to detect 520 data entry is occurring within an application form 320 or 420 of mobile app 310 or online/web platform/application 410 and, in response to data entry detection 520, dynamically capture telemetry data 530 associated with data entry process and/or application form 320, 420. The telemetry data 530 includes, but is not limited to, IP address/geo-location 531 of the data entrant, data entry time 532, data entry rate 533, page rendering parameters 534, user interface interactions 535 and mined data 536.

Further, autonomous software program detection application 510 is configured to apply the captured telemetry data 530 to one or more of the machine learning models 200 to recognize one or more of the patterns 210. In response to recognizing patterns 210, autonomous software program detection application 510 is further configured to determine 550 whether the data entrant is human (i.e., user 302) or an autonomous software program/bot 600 based, at least on the recognized patterns 210 and the captured telemetry data 530.

In other embodiments of the invention, additional techniques are implemented to determine 550 whether the data entrant is human (i.e., user 302) or an autonomous software program/bot 600. For example, in specific embodiments of the invention, autonomous software program detection application 510 is configured to monitor for changes 552 in the IP address and/or geo-location 531 of the data entrant during data entry. Occurrences of changes in the IP address or geo-location 531 may be indicative of an autonomous software program/bot 600, which typically frequently change IP address or spoof different geo-locations to avoid detection. In further specific embodiments of the invention, autonomous software program detection application 510 is configured to use an API 506 to connect with a database storing an IP address dent list 558 to verify that the IP address is not included within the IP address deny list. Inclusion of the IP address within the IP address deny list is indicative of the data entrant more likely being an autonomous software program/bot 600.

In other embodiments of the invention, autonomous software program detection application 510 is configured to use an API 506 to connect to mobile phone intelligence 554 (e.g., Telcos or the like) to verify whether the phone number has been reported or tracked or whether the Subscriber Identity Module (SIM) card has been replaced. Occurrences of mobile phone numbers being reported or tracked or SIM card being replaced/exchanges are typically indicative of phones numbers used by autonomous software programs/bots 600. Similarly, autonomous software program detection application 510 is configured to perform verification 556 on data mined 536 from the entry fields or external databases (e.g., based on the telephone number) using an API 506 to connect to a verification service to verify contact information, such as telephone number, email address, physical address and the like. Verification of contact information provides indication that the data entrant is an actual human/user 302 as opposed to an autonomous software program 600.

In specific embodiments of the invention, autonomous software program detection application 510 implements the other techniques for determination 550 in parallel with the machine learning model 200 determination of the patterns 200. In such embodiments of the invention, autonomous software program detection application 510 takes results of all the determination techniques into consideration when making a determination as to whether the data entrant is human (i.e., user 302) or an autonomous software program/bot 600. For example, a scoring system may be implemented that weights patterns 210 and the results of other determination techniques to determine a score that indicates the likelihood that the data entrant is human (i.e., user 302) or an autonomous software program/bot 600. Based on the score, the data entrant may be determined to be human/user 302, an autonomous software program/bot 600 or unable to confirm whether the data entrant is the human/user 302, an autonomous software program/bot 600. In other specific embodiments of the invention, autonomous software program detection application 510 initially implements the machine-learning learning model 200 to determine recognized patterns 200 and subsequently uses the other determination techniques if the applicable patterns 200 (or the score resulting from the recognized patterns) is not conclusive (i.e., the recognized patterns alone do not provide enough indication as to whether the data entrant is a human/user 302 or an autonomous software program 600).

Moreover, autonomous software program detection application 510 is configured to, in response to determining that the data entrant is an autonomous software program/bot 600, deny submission 560 of the application 320, 420 for further processing. In this regard, if the autonomous software program detection application 510 makes the determination 550 prior to the autonomous software program/bot 600 submitting the application, the submission may be denied (or the submission may be accepted and subsequent processing denied so that the autonomous software program/bot 600 is unaware of the detection). Conversely, if the autonomous software program detection application 510 makes the determination 550 simultaneous with the autonomous software program/bot 600 submitting the application or a brief period after the autonomous software program/bot 600 submits the application, the application may be dropped and/or further processing of the application may be denied.

In additional specific embodiments of the invention, memory 502 stores authorization gateway application 570 which is further configured to verify the user 302 prior to accepting submittal of the application. According to specific embodiments of the invention, authorization gateway application 570 is implemented after the autonomous software program detection application 510 has been executed (i.e., after a determination has been made as to whether the data entrant is a human/user 302 or an autonomous software program 600). In specific embodiments some of the authorization gateway application 570 functionality described herein is performed to confirm that the data entrant is autonomous software program 600.

Authorization gateway application 570 includes KYC (Know Your Customer) check 572 which is configured to verify the identity of the data entrant/user 302. In specific embodiments of the invention KYC check 572 is configured to perform social security number verification 573, although in other embodiments of the invention other personal data may be used to perform the KYC check 572. It should be noted that a KYC check 572 may provide validation that the data entrant is an autonomous software program 600, since autonomous software programs 600 are unable to perform a KYC check 572.

Additionally, authorization gateway application 570 includes a Motor Vehicle Commission (MVC)/Department of Motor Vehicles (DMV) API 506-A which is configured to connect to an MVC or DMV database to perform driver's license verification 575 as a further means of verifying the identity of the data entrant/user 302. Moreover, authorization gateway application 570 includes verification system API which is configured to connect to a verification system, such as a LEXIS/NEXIS® or the like to perform mobile telephone number, electronic mail (Email) and/or physical/mailing address verification of the data entrant/user.

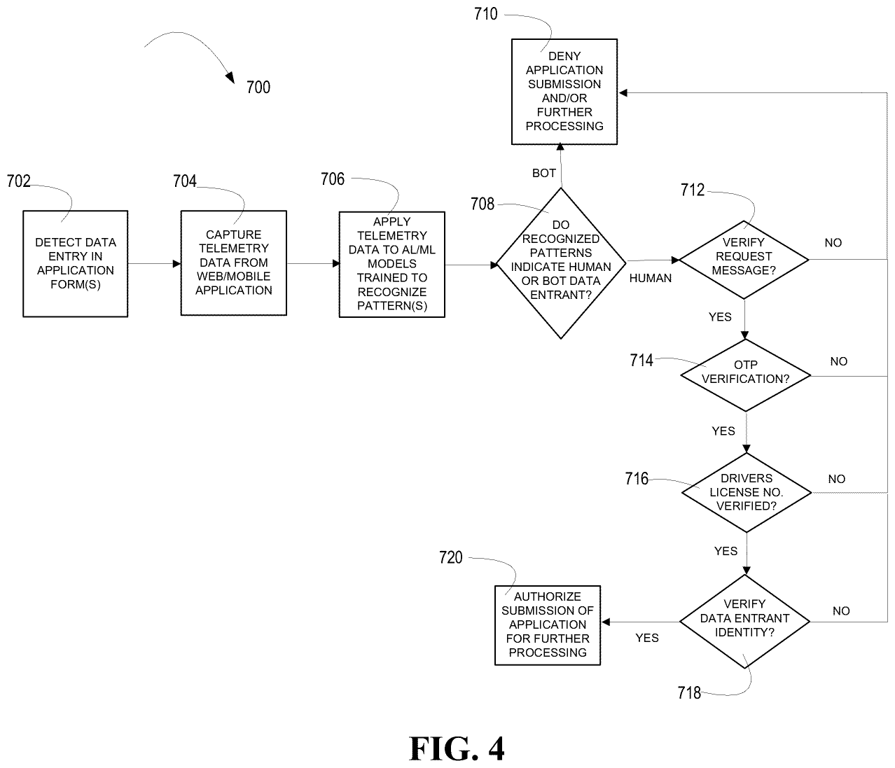

Referring to FIG. 4, a flow diagram is presented of method for application submittal verification including dynamic detection of application submittal by autonomous software programs, in accordance with embodiments of the present invention. At Event 702, data entry is detected within a mobile app or online application form, such as a financial account application form or the like. In response to detection of data entry, at Event 704 telemetry data associated with the application form is captured. The telemetry data may include, but is not limited to, IP address/geo-location of the data entrant, data entry time, data entry rate, data entry sequence/order, page rendering parameters, user interface interactions and mined data.

At Event 706, the telemetry data is applied to Machine Learning (ML) models in real-time to recognize one or more patterns. The patterns are indicative of whether the data entrant is a human or an autonomous software program. At Decision 708, a determination is made as to whether the recognized patterns and, in some instances, standalone telemetry data indicate a humas as the data entrant or an autonomous software program/bot as the data entrant. If the determination is made that the recognized patterns and, in some embodiments, the telemetry data indicate autonomous software program/bot as the data entrant, at Event 710, the application submission and/or further processing of the application is denied.

If the determination is made that the recognized patterns and, in some embodiments, the telemetry data indicate a human as the data entrant (or, in some embodiments if the determination is inconclusive), at Decision 712, a determination is made as to whether a request message has been verified by an Artificial Intelligence (AL)/Machine Learning (ML)-based system. The request message is verified for one or more parameters, including, but not limited to, identification number(s), name, mobile phone number, physical address, email address and the like. In specific embodiments of the invention, the parameters are communicated to the AI/ML-based system in the form of a Non-Fungible Token (NFT). If the request message is no verified, either further verification may be required, or, at Event 710, the application submission and/or further processing of the application is denied.

If the request message is verified, at Decision 714, a determination is made as whether an OTP has been verified. In this regard, an OTP is generated and communicated to the data entrant/user's mobile telephone and to a verification service, such as LEXIS/NEXIS® or the like. If the OTP is not received from the data entrant within the allotted timeframe, either further verification including further OTP verification may be required, or, at Event 710, the application submission and/or further processing of the application is denied.

If the OTP is properly verified, at Decision 716, where applicable, the driver's license number of the data entrant is verified. In this regard, an API makes a call-out to a MVC or DMY to verify that the submitted driver's license number is the driver's license number assigned to the data entrant/user. If the driver's license number can not be verified further verification including further OTP verification may be required, or, at Event 710, the application submission and/or further processing of the application is denied.

If, where applicable, the driver's license is properly verified, at Decision 718 data entrant identity is verified. In this regard, an API call-out is made to a verification system, to verify one or more of the user's name, social security number, email address and the like. If the personal information cannot be verified further verification including further identity verification may be required, or, at Event 710, the application submission and/or further processing of the application is denied.

If the identity of the data entrant is properly verified, at Event 720, submission of the application is authorized for further downstream processing. It should be noted that the order in which verification steps are conducted is by way of example only and that verification steps can be performed in any order and/or in parallel.

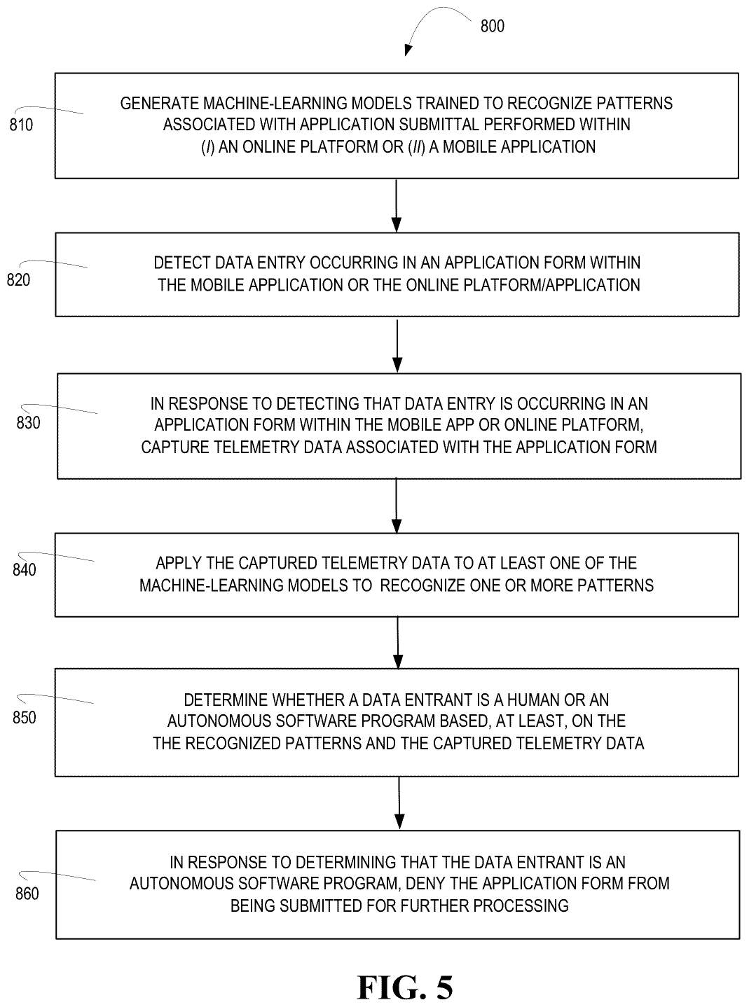

Referring to FIG. 5, a flow diagram is presented of a method 800 for dynamic detection of mobile/online application submissions by autonomous software programs, in accordance with embodiments of the present invention. At Event 810, one or more machine learning models are trained, over time, to recognize patterns associated with application submittal, such as a financial account application submittal conducted within a mobile application or online platform/application. The patterns may be indicative of the data entrant either being a human (i.e., valid application submission) or an autonomous software program (i.e., invalid application submission) attempting to create a fake account.

At Event 820, data entry is detected as occurring within data entry fields of application form within the mobile application or online platform/application. In response to detecting the occurrence of data entry within the data fields of the application form, at Event 830, telemetry data associated with the application form is captured. The telemetry data may include, but ids not limited to, IP address/geo-location of the data entrant, data entry time, data entry rate, data entry sequence/order, page rendering parameters, user interface interactions and mined data.

At Event 840, the captured telemetry data is applied to the machine learning models to recognize one or more of the patterns and, at Event 850, a determination is made as to whether the data entrant is a human or an autonomous software program/bot based, at least on the recognized patterns and the telemetry data. In specific embodiments of the invention, the determination as to whether the data entrant is a human or an autonomous software program/bot is based further on changes of the IP Address or geo-location during data entry, IP address verification, mobile telephone intelligence, mined data and the like.

In response to determining that the data entrant is an autonomous software program/bot, at Event 860, submission and/or further processing of the application is denied. In this regard, determination occurs prior to application submission, the submission is denied (or the submission may be accepted and subsequent processing denied so that the submission appears to be the bot as being valid). Conversely, if the determination is made simultaneous with the application submittal or a brief period after the application submittal, the application may be dropped and/or further processing of the application may be denied.

Thus, present embodiments of the invention discussed in detail above, provide for intelligently and dynamically detecting mobile app or online application submissions being filled-out by autonomous software programs, such as bots or the like. In response detecting data entry within a mobile app or online application form, the invention captures telemetry data from the mobile app or web/online application that is indicative as to whether the application forms are being filled-out by a human or an autonomous software program. The telemetry data is compared to patterns recognized by machine learning models to determine if the telemetry data matches a pattern that indicates human data entry or, conversely, a pattern that indicates autonomous software program data entry. In the event that an application submission is determined to be filled-out by an autonomous software program, subsequent submission and/or further processing of the application (i.e., entry of the application into the processing system) is be denied.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for dynamic detection of application submissions generated by autonomous software programs, the system comprising:
one or more machine-learning models trained to recognize patterns associated with application submittal performed within (i) an online platform, or (ii) a mobile application; and
a computing platform including a memory and one or more computing processor devices in communication with the memory, wherein the memory stores autonomous software program detection application executable by at least one of the one or more computing processor devices and configured to:
detect data entry is occurring in an application form within the mobile application or the online platform,
in response to detecting data entry is occurring, capture telemetry data associated with the application form,
apply the captured telemetry data to at least one of the one or more machine-learning models to recognize one or more of the patterns,
determine whether a data entrant is a human or an autonomous software program based, at least one, the one or more recognized patterns and the captured telemetry data, and
in response to determining that the data entrant is an autonomous software program, deny the application form from being submitted for further processing.

2. The system of claim 1, wherein the one or more machine-learning models are trained to recognize patterns, wherein the patterns include a timing pattern for application form completion and wherein the autonomous software program detection application is configured to (i) capture telemetry data including a time for application form completion and (ii) determine whether the data entry is being made by a human or an autonomous software program based on a the time for application form completion meeting the timing pattern.

3. The system of claim 1, wherein the one or more machine-learning models are trained to recognize patterns, wherein the patterns include at least one of (i) a data entry rate pattern, and (ii) a data entry sequence pattern and wherein the autonomous software program detection application is configured to (a) capture telemetry data including at least one of a current data entry rate and a current data entry sequence and (b) determine whether the data entry is being made by a human or an autonomous software program based the current data entry rate meeting the data entry rate pattern or the current data entry sequence meeting the data entry sequence pattern.

4. The system of claim 1, wherein the one or more machine-learning models are trained to recognize patterns, wherein the patterns include a page rendering pattern for loading pages on the online platform or mobile application and wherein the autonomous software program detection application is configured to (i) capture telemetry data including page rendering parameters and (ii) determine whether the data entry is being made by a human or an autonomous software program based on comparison the page rendering parameters meeting the page rendering pattern.

5. The system of claim 4, wherein the page rendering pattern includes at least one selected from the group consisting of (i) JavaScript (JS) files that are loaded, (ii) Cascading Style Sheet (CSS) that are loaded, (iii) source code that is loaded, and (iv) events triggered on web page.

6. The system of claim 1, wherein the one or more machine-learning models are trained to recognize patterns, wherein the patterns include a user interface interaction pattern and wherein the autonomous software program detection application is configured to (i) capture telemetry data including user interface interactions, and (ii) determine whether the data entry is being made by a human or an autonomous software program based on the user interface interactions meeting the user interface interaction pattern.

7. The system of claim 1, wherein the autonomous software program detection application is further configured to monitor for changes in an Internet Protocol (IP) address and geographic (geo) location of the data entrant and determine whether the data entry is being made by a human or an autonomous software program based further on the monitored changes in the IP address and geo location of the data entrant.

8. The system of claim 1, wherein the autonomous software program detection application is further configured to monitor for data entrant tampering of at least one selected from the group consisting of (i) Cascading Style Sheet (CSS) in JavaScript (JS), (ii) local cache, and (iii) communication network and, determine whether the data entry is being made by a human or an autonomous software program based further on data entrant tampering of the at least one selected from the group consisting of (i) CSS in JS, (ii) local cache, and (iii) communication network.

9. The system of claim 1, wherein the autonomous software program detection application is further configured to receive mobile telephone intelligence that indicates that a mobile telephone being used by the data entrant has been reported, tracked or undergone Subscriber Identity Module (SIM) card exchange and determine whether the data entry is being made by a human or an autonomous software program based further on reporting, tracking or SIM card exchange of/within the mobile telephone being used by the data entrant.

10. The system of claim 1, wherein the autonomous software program detection application is further configured to attempt identity verification of the data entrant based on data entries made to the application form and determine whether the data entry is being made by a human or an autonomous software program based further on results of the attempted identity verification of the data entrant.

11. The system of claim 1, wherein the autonomous software program detection application is further configured to compare the IP address of a data entrant to an IP addresses currently listed on an IP address deny list and determine whether the data entry is being made by a human or an autonomous software program based further on comparison between the IP address of the data entrant and the IP addresses currently listed on the IP address deny list.

12. The system of claim 1, wherein the memory further stores an authorization gateway application that is executable by at least one of the one or more computing processor devices and configured to:
in response to determining that the data entrant is a human, contact a corresponding motor vehicle commission to validate a driver license number associated with the data entrant.

13. The system of claim 1, wherein the authorization gateway application is further configured to:
in response to determining that the data entrant is a human, contact a verification system to validate at least one selected from the group consisting of the data entrant's (i) mobile telephone number, (ii) electronic mail address, and (iii) mailing address.

14. A computer-implemented method for dynamic detection of application submissions generated by autonomous software programs, the method being executable by one or more computing device processors and comprising:
generating machine-learning models trained to recognize patterns associated with application submittal performed within at least one selected from the group consisting of (i) an online platform and (ii) a mobile application;
detecting data entry is occurring in an application form within the mobile application or the online platform,
in response to detecting data entry is occurring, capturing telemetry data associated with the application form,
applying the captured telemetry data to at least one of the one or more machine-learning models to recognize one or more of the patterns,
determining whether a data entrant is a human or an autonomous software program based, at least one, the one or more recognized patterns and the captured telemetry data; and
in response to determining that the data entrant is an autonomous software program, denying the application form from being submitted for further processing.

15. The computer-implemented method of claim 14, wherein:
generating the machine-learning models trained to recognize patterns associated with application submittal, wherein the patterns include at least one of (i) a timing pattern for application form completion, (ii) a data entry rate pattern, and (ii) a data entry sequence pattern,
capturing the telemetry data, wherein the telemetry data includes at least one of (i) a time for application form completion, (ii) a current data entry rate, and (iii) a current data entry sequence, and
determining whether the data entry is being made by a human or an autonomous software program is based on at least one of (i) the time for application form completion meeting the timing pattern, (ii) the current data entry rate meeting the data entry rate pattern, and (iii) the current data entry sequence meeting the data entry sequence pattern.

16. The computer-implemented method of claim 14, wherein:
generating the machine-learning models trained to recognize patterns associated with application submittal, wherein the patterns include a page rendering pattern includes at least one selected from the group consisting of (i) JavaScript (JS) files that are loaded, (ii) Cascading Style Sheet (CSS) that are loaded, (iii) source code that is loaded, and (iv) events triggered on web page,
capturing the telemetry data, wherein the telemetry data includes page rendering parameters, and
determining whether the data entry is being made by a human or an autonomous software program is based on the page rendering parameters meeting the page rendering pattern.

17. The computer-implemented method of claim 14, further comprising:
monitor for at least one selected from the group consisting of (i) changes in an Internet Protocol (IP) address and geographic (geo) location of the data entrant and (ii) data entrant tampering of at least one selected from the group consisting of (a) Cascading Style Sheet (CSS) in JavaScript (JS), (b) local cache, and (c) communication network, and
wherein determining whether the data entry is being made by a human or an autonomous software program based further on at least one selected from the group consisting of the monitored (i) changes in the IP address and geo location of the data entrant and (ii) data entrant tampering of the at least one selected from the group consisting of (a) CSS in JS, (b) local cache, and (c) communication network.

18. A computer program product comprising:
a non-transitory computer-readable medium comprising sets of codes for causing one or more computing devices to:
generate machine-learning models trained to recognize patterns associated with application submittal performed within at least one selected from the group consisting of (i) an online platform and (ii) a mobile application;
detect data entry is occurring in an application form within the mobile application or the online platform,
in response to detecting data entry is occurring, capture telemetry data associated with the application form,
apply the captured telemetry data to at least one of the one or more machine-learning models to recognize one or more of the patterns,
determine whether a data entrant is a human or an autonomous software program based, at least one, the one or more recognized patterns and the captured telemetry data; and
in response to determining that the data entrant is an autonomous software program, deny the application form from being submitted for further processing.

19. The computer program product of claim 18, wherein the set of codes for causing the one or more computing devices to generate the machine-learning models are further configured to cause the one or more computing devices to generate the machine-learning models trained to recognize patterns associated with application submittal, wherein the patterns include at least one of (i) a timing pattern for application form completion, (ii) a data entry rate pattern, and (iii) a data entry sequence pattern.

20. The computer program product of claim 19, wherein the set of codes for causing the one or more computing devices to capture the telemetry data are further configured to cause the one or more computing devices to capture the telemetry data, wherein the telemetry data includes at least one of (i) a time for application form completion, (ii) a current data entry rate, and (iii) a current data entry sequence, and
the set of codes for causing the one or more computing devices to determine whether the data entry is being made by a human or an autonomous software program are further configured to cause the one or more computing devices to determine whether the data entry is being made by a human or an autonomous software program is based on at least one of (i) the time for application form completion meeting the timing pattern (ii) the current data entry rate meeting the data entry rate pattern, and (iii) the current data entry sequence meeting the data entry sequence pattern.
